(19) United States
(12) Patent Application Publication
(10) Pub. No.: US 2017/0288320 A1
(43) Pub. Date: Oct. 5, 2017

(54) WEDGE CARTOUCHE

(71) Applicant: Cicame Énergie Inc., Longueuil (CA)

(72) Inventors: Geneviève Soucy, Chambly (CA); Nicolas Hillion, Chambly (CA)

(21) Appl. No.: 15/510,510

(22) PCT Filed: Sep. 11, 2015
(86) PCT No.: PCT/CA2015/050883

§ 371 Date: Mar. 10, 2017

Related U.S. Application Data
(60) Provisional application No. 62/049,134, filed on Sep. 11, 2014.

(51) Int. Cl. H01R 4/50; H01R 4/08

(52) U.S. Cl. CPC H01R 4/5083; H01R 4/08

(57) ABSTRACT

A wedge cartouche (1) for use with at least one line (3) and corresponding containment assembly (5). The wedge cartouche (1) includes at least one wedging 5 component (7) being positioned, shaped and sized for inserting inside the containment assembly (5), adjacent to the at least one line having a segment (9) extending through said containment assembly (5), the at least one wedging component (7) being moveable along at least one given path (11), and being operable between opposite drawn-in and drawn-out configurations along said at 10 least one given path (11). The wedge cartouche (1) also includes and a blasting assembly (13) for propelling the at least one wedging component (7) into the drawn-out configuration, in order to operatively secure the segment (9) of the at least one line (3) between a receiving portion (15) of the containment assembly (5) and said at least one drawn-out wedging component (7). 15

### FIELD OF THE INVENTION

The present invention relates to a wedging device. More particularly, in its preferred intended use, the present invention relates to a wedge cartouche for use with at least one line, and also relates to at least one line provided with such a wedge cartouche, and to a corresponding method of assembling and using associated thereto.

### BACKGROUND OF THE INVENTION

Wedging devices are well known in the art. For example, known to the Applicant are the following prior art references:

AU 720279; AU 4233899; AU 4233999; BR 9200685 A; BR 9603537-4 A; CA 2,286,923 A1; CA 2,334,187 A1; CN 1965447 A; EP 0 762 543 A1; FR 2 377 099 A1; FR 2 714 702 A1; GB 929,387; GB 2 011 008 A; GB 2 311 664 A; GB 2 436 441 A; JP 10-302858; JP 63-214509; JP 63-214510; JP 2000-192747; JP 2006-304597; MX PA0400032 A; MX PA96003353 A; U.S. Pat. No. 1,801,277; U.S. Pat. No. 3,304,962; U.S. Pat. No. 3,305,253; U.S. Pat. No. 3,588,791; U.S. Pat. No. 3,588,793; U.S. Pat. No. 3,931,726; U.S. Pat. No. 4,027,939; U.S. Pat. No. 4,114,977; U.S. Pat. No. 4,252,992; U.S. Pat. No. 4,279,461; U.S. Pat. No. 4,374,483; U.S. Pat. No. 4,415,222; U.S. Pat. No. 4,494,890; U.S. Pat. No. 4,650,273; U.S. Pat. No. 4,730,087; U.S. Pat. No. 4,863,403; U.S. Pat. No. 5,044,996; U.S. Pat. No. 5,076,596; U.S. Pat. No. 5,152,701; U.S. Pat. No. 5,190,300; U.S. Pat. No. 5,244,422; U.S. Pat. No. 5,320,565; U.S. Pat. No. 5,507,652; U.S. Pat. No. 5,507,671; U.S. Pat. No. 5,558,546; U.S. Pat. No. 5,613,883; U.S. Pat. No. 5,774,987; U.S. Pat. No. 5,820,422; U.S. Pat. No. 5,830,019; U.S. Pat. No. 5,862,589; U.S. Pat. No. 5,868,588; U.S. Pat. No. 5,944,565; U.S. Pat. No. 6,273,765 B1; U.S. Pat. No. 6,309,261 B1; U.S. Pat. No. 7,794,291 B2; U.S. Pat. No. 7,993,169 B1; US 2002/0142674 A1; US 2003/0148670 A1; USS 2005/0233650 A1; WO 02/01676 A1; WO 93/06958 A1; WO 99/31761 A1; WO 99/31762 A1; WO 2005/122336 A2; WO 2006/016940 A1; and WO 2006/073656 A1.

Despite all of these different conventional wedging devices, there is always a need to continue improving and find better and/or different ways of securing a line onto a corresponding component (ex. during derivating of a power line, etc.), in a simpler, easier, faster, more cost-effective and/or safer manner, especially when operated remotely via a hot stick, for example.

### SUMMARY OF THE INVENTION

An object of the present invention is to provide a wedge cartouche which, by virtue of its design and components, satisfies some of the above-mentioned needs and which is thus an improvement over other related wedging devices and/or methods known in the prior art.

In accordance with the present invention, the above object is achieved, as will be easily understood from the present description, with a wedge cartouche such as the one briefly described herein and such as the one exemplified in the accompanying drawings.

According to one aspect of the present invention, there is provided a wedge cartouche for use with at least one line and corresponding containment assembly, the wedge cartouche comprising:

at least one wedging component being positioned, shaped and sized for inserting inside the containment assembly, adjacent to the at least one line having a segment extending through said containment assembly, the at least one wedging component being moveable along at least one given path, and being operable between opposite drawn-in and drawn-out configurations along said at least one given path; and

a blasting assembly for propelling the at least one wedging component into the drawn-out configuration, in order to operatively secure the segment of the at least one line between a receiving portion of the containment assembly and said at least one drawn-out wedging component.

According to yet another aspect of the present invention, there is also provided a wedge cartouche assembly for use with at least one line, the wedge cartouche assembly including the present wedge cartouche, and at least one other one of the following components: at least one line; a base component; a containment component; a blasting (i.e. propelling, etc.) component/assembly; and/or another complementary (i.e. accessory) component.

According to another aspect of the invention, there is also provided at least one line (ex. a powerline, etc.) provided with at least one of the above-mentioned wedge cartouche and/or wedge cartouche assembly.

According to yet another aspect of the invention, there is also provided a method of using and/or operating the above-mentioned wedge cartouche, wedge cartouche assembly and/or component(s) thereof.

According to yet another aspect of the invention, there is also provided a method of wedging (ex. clamping, securing, anchoring, etc.) the above-mentioned wedge cartouche, wedge cartouche assembly and/or component(s) thereof onto at least one line.

According to yet another aspect of the invention, there is also provided a method of manufacturing the above-mentioned wedge cartouche, wedge cartouche assembly and/or component(s) thereof.

According to yet another aspect of the invention, there is also provided a kit with components for assembling the above-mentioned wedge cartouche and/or wedge cartouche assembly.

According to yet another aspect of the present invention, there is also provided a set of components for interchanging with components of the above-mentioned kit.

According to yet another aspect of the present invention, there is also provided a method of assembling components of the above-mentioned kit and/or set.

According to yet another aspect of the present invention, there is also provided a method of doing business with the above-mentioned wedge cartouche, method(s) kit and/or set.

The objects, advantages, and other features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIGS. 1-39 are different views of a wedge cartouche and/or component(s) thereof according to possible embodiments of the present invention, in different operating configurations, and shown cooperating in some cases with a plurality of lines.

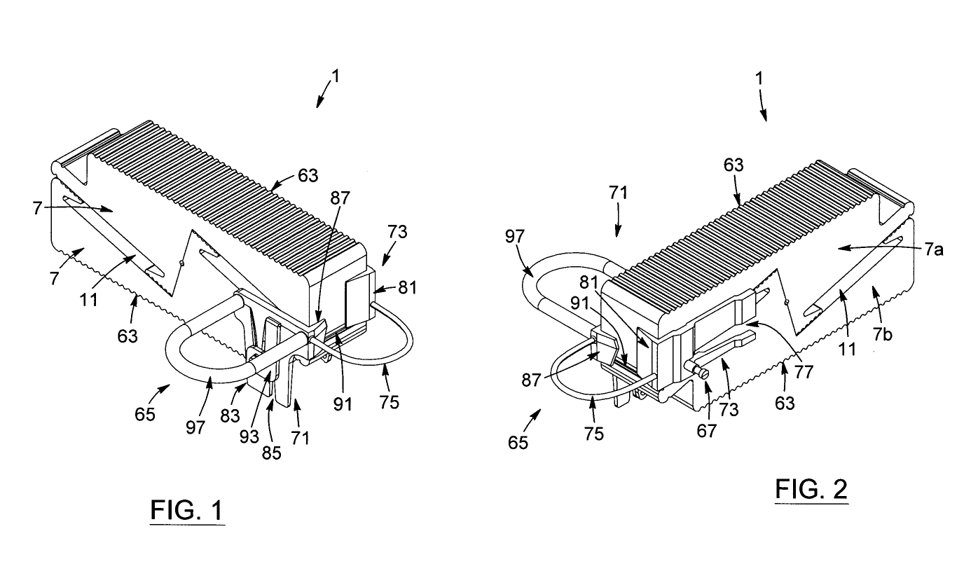

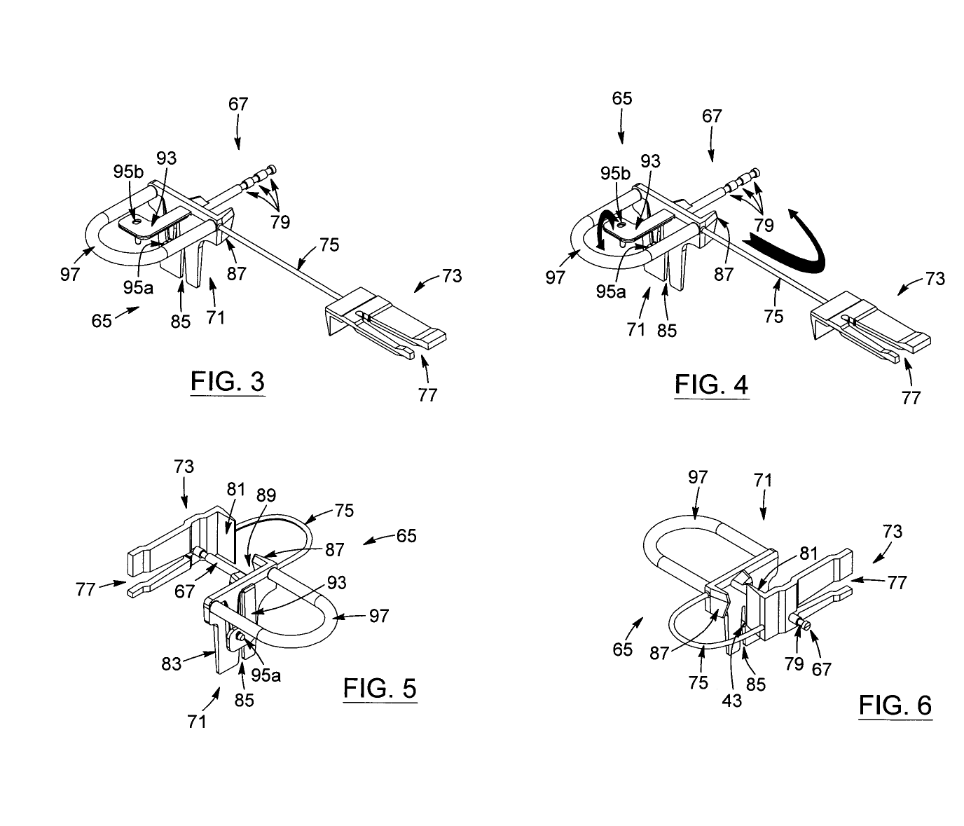

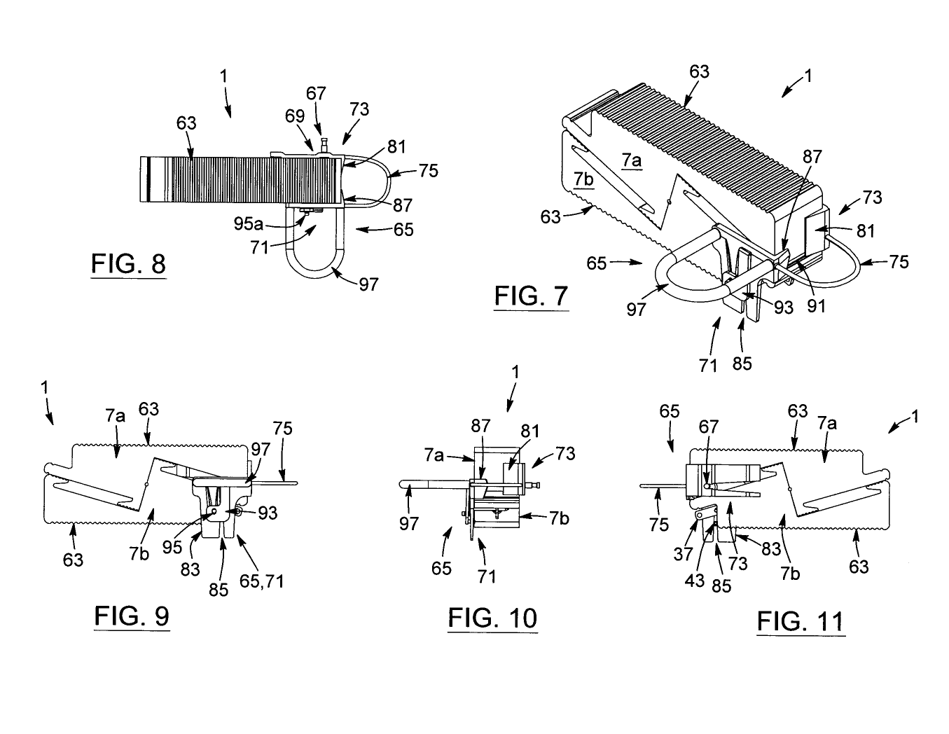

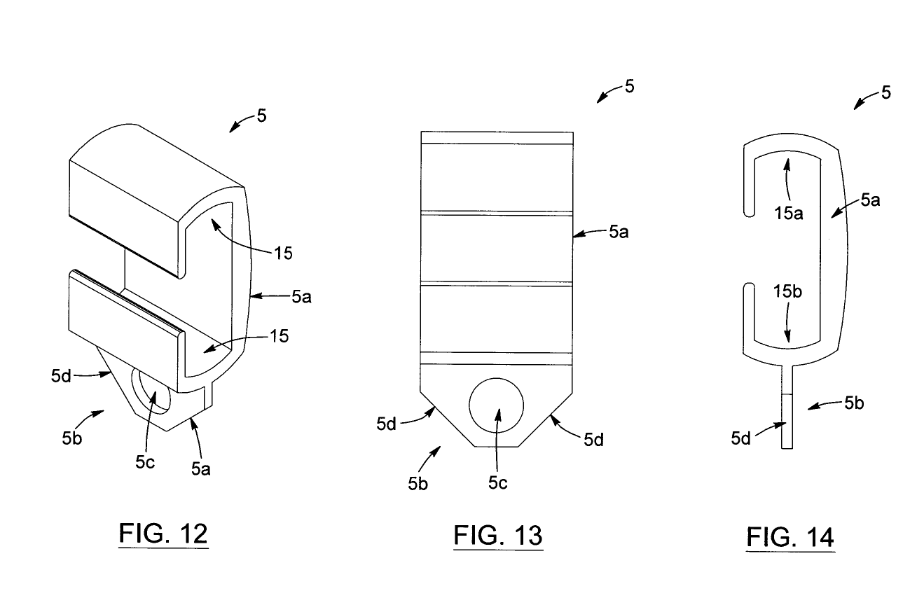

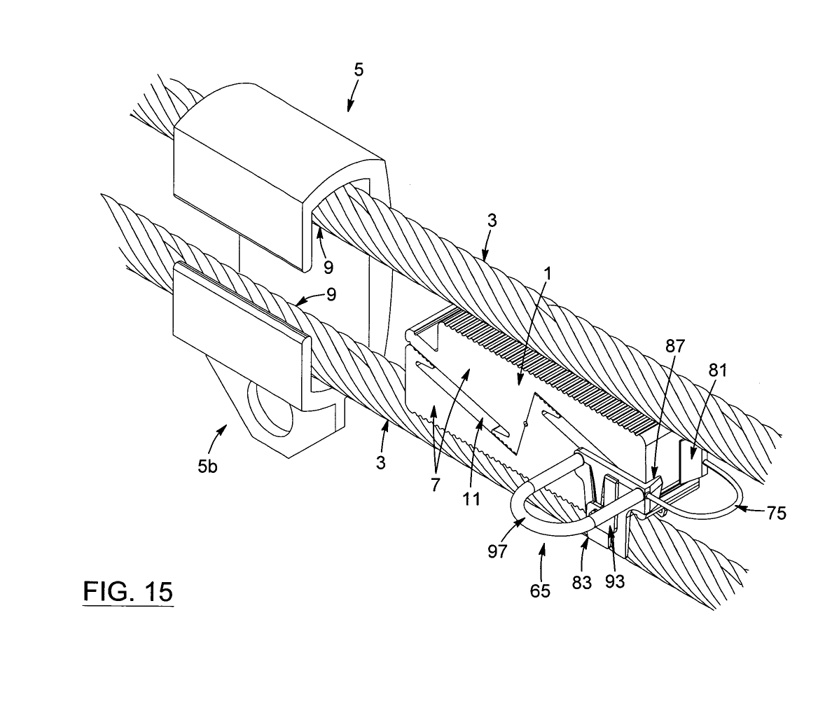

### DETAILED DESCRIPTION OF PREFERRED EMBODIMENTS OF THE INVENTION

In the following description, the same numerical references refer to similar elements. Furthermore, for sake of simplicity and clarity, namely so as to not unduly burden the figures with several reference numbers, only some figures have been provided with reference numbers, and components and features of the present invention illustrated in other figures can be easily inferred therefrom. The embodiments, geometrical configurations, materials mentioned and/or dimensions shown in the figures are preferred, for exemplification purposes only.

Moreover, although the present invention was primarily designed for wedging a wedging cartouche onto at least one line, such as a power line, for example, it may be used with other objects and/or in other types of applications, as apparent to a person skilled in the art. For this reason, expressions such as “wedge”, “cartouche”, “wedging”, “line”, “power line”, etc., used herein should not be taken so as to limit the scope of the present invention and include all other kinds of objects and/or applications with which the present invention could be used and may be useful (ex. the line need not to be under tension or electrified, for the present wedge cartouche to be used, etc.—indeed, the present wedge cartouche could simply be used as a clamping device for clamping onto any elongated object, such as a cord, wire, rope, etc.).

Moreover, in the context of the present invention, the expressions “wedge”, “cartouche”, “assembly”, “device”, “apparatus”, “system”, “unit”, “assembly”, “product”, “equipment”, “tool”, “method” and “kit”, as well as any other equivalent expressions and/or compounds word thereof known in the art will be used interchangeably, as apparent to a person skilled in the art. This applies also for any other mutually equivalent expressions, such as, for example: a) “wedging”, “anchoring”, “securing”, “clamping”, “connecting”, “affixing”, “restraining”, “holding”, “fastening”, “interconnecting”, etc.; b) “blasting”, “explosive”, “impulsion”, “propelling”, “expanding”, “separating”, “bursting away”, etc.; c) “moveable”, “displaceable”, “sliding”, “gliding”, “moving”, “skidding”, “distancing”, “separating”, etc.; d) “path”, “track”, “rail”, “guide”, “support”, “slope”, “section”, etc.; e) “drawn-out”, “drawn-away”, “spaced-apart”, “propelled”, “separated”, “expanded”, “operable”, “active”, etc.; f) “configuration”, “mode”, “status”, etc.; as well as for any other mutually equivalent expressions, pertaining to the aforementioned expressions (and/or to antonyms thereof) and/or to any other structural and/or functional aspects of the present invention, as also apparent to a person skilled in the art.

Furthermore, in the context of the present description, it will be considered that all elongated objects will have an implicit “longitudinal axis” or “centerline”, such as the longitudinal axis of a line for example, or the centerline of a bore, for example, and that expressions such as “connected” and “connectable”, or “mounted” and “mountable”, may be interchangeable, in that the present invention also relates to a kit with corresponding components for assembling a resulting fully assembled and operational wedge cartouche (and/or at least one line including the same).

Moreover, components of the present system(s) and/or steps of the method(s) described herein could be modified, simplified, altered, omitted and/or interchanged, without departing from the scope of the present invention, depending on the particular applications which the present invention is intended for, and the desired end results, as briefly exemplified herein and as also apparent to a person skilled in the art.

In addition, although the preferred embodiments of the present invention as illustrated in the accompanying drawings comprise various components, and although the preferred embodiments of the wedge cartouche and corresponding parts as shown consist of certain geometrical configurations as explained and illustrated herein, not all of these components and geometries are essential to the invention and thus should not be taken in their restrictive sense, i.e. should not be taken so as to limit the scope of the present invention. It is to be understood, as also apparent to a person skilled in the art, that other suitable components and cooperation thereinbetween, as well as other suitable geometrical configurations may be used for the wedge cartouche (and/or portions thereof) and corresponding parts according to the present invention, as will be briefly explained herein and as can be easily inferred herefrom by a person skilled in the art, without departing from the scope of the present invention.

Broadly described, and as better exemplified in the accompanying drawings, the present invention relates to a wedge cartouche enabling to “wedge” (i.e. secure, anchor, affix, hold, maintain, clamp, connect, etc.) a portion of at least one line, onto a corresponding component (ex. during derivating of a power line, etc.), in a simpler, easier, faster, more cost-effective and/or safer manner, than what is possible with other conventional systems.

Namely, and as can be easily understood by the accompanying drawings, the present wedge cartouche (1) is preferably meant to be mounted on and/or about, and used with at least one line (3) (ex. cord, rope, string, elongated object, etc.), so as to clamp a portion of said at least one line (3), and according to another possible embodiment, clamp at least two lines (3a,3b) together, in the manner described and exemplified in the present description.

The present wedge cartouche (1) may come in various shapes and/or forms and may include one and/or several of the following components and features (and/or different combination(s) thereof, etc.).

Indeed, according to one aspect of the present invention, there is provided, a wedge cartouche (1) for use with at least one line (3) and corresponding containment assembly (5). The wedge cartouche (1) can comprise at least one wedging component (7) being positioned, shaped and sized for inserting inside the containment assembly (5), adjacent to the at least one line (3) having a segment (9) extending through said containment assembly (5), the at least one wedging component (7) being moveable along at least one given path (11), and being operable between opposite drawn-in and drawn-out configurations along said at least one given path (11). The wedge cartouche (1) can also comprise a blasting assembly (13) for propelling the at least one wedging component (7) into the drawn-out configuration, in order to operatively secure the segment (9) of the at least one line (3) between a receiving portion (15) of the containment assembly (5) and said at least one drawn-out wedging component (7).

The blasting assembly (13) may come in various different forms, but according to one possible embodiment, it includes a blank cartridge (17) having propellant (19) and a corresponding priming component (21) for igniting the propellant (19). The blasting assembly (13) may also include a barrel (23) for containing the blank cartridge (17) inside said barrel (23), and the barrel (23) may comprise an orifice (25) for exposing the priming component (21) of the blank cartridge (17), in order to receiving a corresponding striking component (37).

According to one possible embodiment, the barrel (23) is made of a resilient material, and an outer distal rim (27) of said barrel (23) is positioned, shaped and sized for resting against an inner wall (29) of an inner cavity (31) of the at least one wedging component (7), such as a top wedging component (7a), for example, in order to assist in containing an explosive effect of the blank cartridge (17) inside said inner cavity (31) of the at least one wedging component (7).

Optionally also, the barrel (23) can be made of a color different than that of the at least one wedging component (7), and the barrel (23) may be further positioned, shaped and sized about the wedge cartouche (1) so as to have an exposed portion after the blasting assembly (13) has propelled the at least one wedging component (7), in order to enable a user of the wedge cartouche (1) to visually determine at a distance when the at least one wedging component (7) is in the drawn-out configuration.

Alternatively, and as can also be easily understood from the accompanying figures, the at least one wedging component (7), such as a bottom wedging component (7b), for example, may comprise a first recess (33a) for removably receiving (ex. via press-fitting, interlocking, etc.) a first portion of the blasting assembly (13), such as a first portion of the barrel (23), for example.

This at least one wedging component (7), such as the bottom wedging component (7b), for example, may also comprise a second recess (33b) for removably receiving a detonating assembly (35) being configured for selectively detonating the blasting assembly (13).

According to one possible embodiment, the detonating assembly (35) may comprise a striking component (37) extendable through the second recess (33b), the striking component (37) having a striking tip (39) being configured for striking the priming component (21) of the blank cartridge (17).

This same at least one wedging component (7), such as the bottom wedging component (7b), for example, may also comprise a third recess (33c) for removably receiving the striking component (37) being extendable through said third recess (33c), the striking component (37) including a hole (41) for receiving a corresponding retaining pin (43) of the detonating assembly (35).

According to the embodiments shown in the accompanying figures, the at least one wedging component (7), and more particularly, the bottom wedging component (7b), for example, may comprise a common recess (33) having corresponding different cross-sectional areas. Namely, the aforementioned the first, second and third recesses (33a, 33b, 33c) can be part of a same and common (33) recess having different cross-sectional profiles.

As can also be easily understood from the accompanying figures, the striking component (37) may comprise a protruding portion (45) extendable outwardly from the at least one wedging component (7), and a portion of the striking component (37), including at least one corresponding hole (41), may be positionable outside of the at least one wedging component (7) when the striking component (37) is in a retracted position.

Optionally also, the at least one wedging component (7) comprises a cut-out section (47) for receiving the protruding portion (45) of the striking component (37).

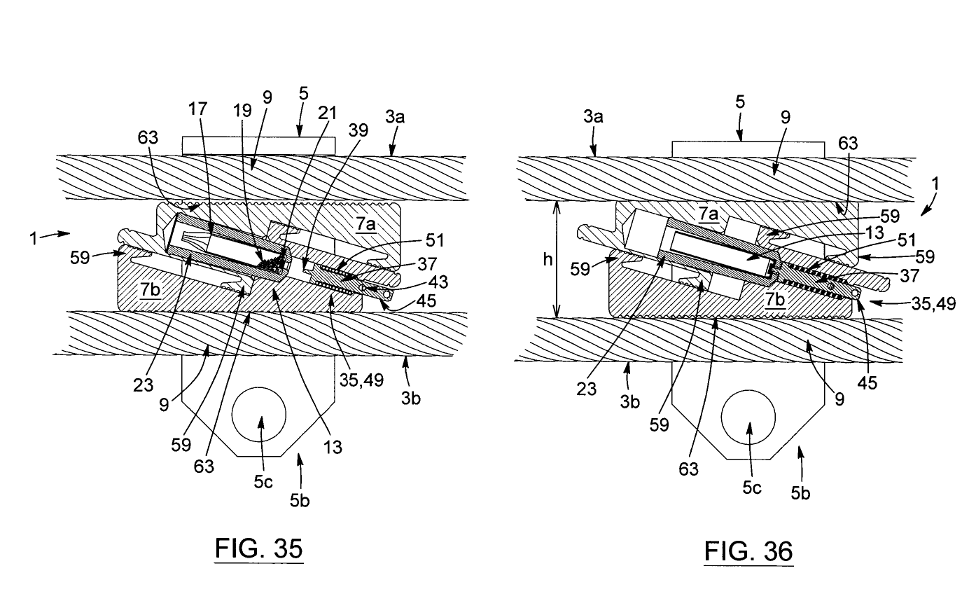

According to one possible embodiment, the striking component (37) may be urged towards the blank cartridge (17) via a biasing assembly (49), and the striking component (37) can be selectively maintained in a retracted configuration via a retaining mechanism (43), such as the retaining pin (43), for example, the retaining pin (43) being insertable into the hole (41) of the striking component (37) when the striking component (37) is in the retracted configuration, and the retaining pin (43) being further positioned, shaped and sized for abutting against an outer portion of the at least one wedging component (7), in order to selectively prevent the striking component (37) from being urged towards the blank cartridge (17), as can be easily understood from FIG. 35, for instance.

The striking component (37) can be spring-loaded via a corresponding spring (51) insertable into a corresponding recess (33) of the at least one wedging component (7), the spring (51) being extendable between a shouldering portion (53) of the striking component (37) and a corresponding inner edge (55) of the at least one wedging component (7), for example.

According to a possible embodiment, the at least one wedging component (7) comprises first and second wedging components (7a,7b) being positioned, shaped and sized for inserting inside the containment assembly (5), adjacent to the at least one line (3) having the segment (9) extending through said containment assembly (5), and the first and second components (7a,7b) are configured to be moveable with respect to one another along the at least one given path (11), and are operable between opposite drawn-in and drawn-out configurations along said at least one given path (11).

The at least one given path (11) may be a slanted path, but could take on other suitable shapes and forms, depending on the particular needs and/or the desired end results.

According to the embodiments shown in the accompanying figures, the first and second wedging components (7a,7b) are moveable with respect to one another so as to increase an effective height (h) of the wedge cartouche (1) upon a detonation of the blasting assembly (13), in order to forcefully jam the segment (9) of the at least one line (7) against the receiving portion (15) of the containment assembly (5), as can be easily understood from FIGS. 35 and 36, for example.

As also shown in the accompanying figures, the first wedging component (7a) may comprise at least one sloping section (57), but preferably, comprises first and second sloping sections (57). Similarly, the second wedging component (7b) may comprise at least one sloping section (57), but preferably, comprises first and second sloping sections (57).

As also shown, the second wedging component (7b) may comprise a first sliding section (59) configured for sliding along a corresponding first section of the first wedging component (7a), and in the examples illustrated, the first section of the first wedging component (7a) includes at least one sloping section (57).

Similarly, the second wedging component (7b) may comprises a second sliding section (59) configured for sliding along a corresponding second section of the first wedging component (7a), and in the examples illustrated, the second section of the first wedging component (7a) includes at least one sloping section (57).

Conversely, the first wedging component (7a) may comprise a first sliding section (59) configured for sliding along a corresponding first section of the second wedging component (7b), and in the examples illustrated, the first section of the second wedging component (7b) includes at least one sloping section (57).

Similarly, the first wedging component (7a) may comprise a second sliding section (59) configured for sliding along a corresponding second section of the second wedging component (7b), and in the examples illustrated, the second section of the second wedging component (7b) includes at least one sloping section (57).

According to one possible embodiment, each sliding section (59) is hook-shaped, with a tapered section (59a) and a grooved section (59b), the tapered section (59a) of a sliding section (59) of one wedging component (7a,7b) being configured for abutting into the grooved section (59b) of a sliding section (59) of another wedging component (7b,7a).

Optionally also, each sliding section (59) includes an outer gripping section (61), the outer gripping section (61) of a sliding section (59) of one wedging component (7a,7b) being configured for gripping into a corresponding section of another wedging component (7b,7a), and/or vice versa, and said corresponding section of another wedging component (7b,7a) may include at one sloping section (57) and/or other suitable section.

Preferably also, each outer gripping section (61) of each sliding section (59) is provided with surface-texturing for improved gripping when the wedge cartouche (1) is propelled into the drawn-out configuration by the blasting assembly (13), and according to one possible embodiment, the surface-texturing can include “peaked” undulations, which are meant to “bite” (i.e. grip, anchor, set, etc.) into the corresponding receiving section.

Similarly, each wedging component (7a,7b) includes an outer gripping section (63), the outer gripping section (63) of each wedging component (7a,7b) being configured for gripping into the segment (9) of the at least one line (7) to be secured onto the receiving portion (15) of the containment assembly (5).

According to the embodiments shown in the accompanying figures, the first and second wedging components (7a,7b) each include an outer gripping section (63), the outer gripping section (63) of the first wedging component (7a) being configured for gripping into a segment (9a) of a first line (3a) to be secured onto a first receiving portion (15a) of the containment assembly (5), and the outer gripping section (63) of the second wedging component (7b) being configured for gripping into a segment (9b) of a second line (3b) to be secured onto a second receiving portion (15b) of the containment assembly (5).

Preferably also, each outer gripping section (63) of each wedging component (7a,7b) is provided with surface-texturing for improved gripping when the wedge cartouche (1) is propelled into the drawn-out configuration by the blasting assembly, and according to one possible embodiment, the surface-texturing may include “rounded” undulations, so as to minimize damage and/or deformation to the at least one line (3).

As can also been easily understood when referring to the accompanying figures, the present wedge cartouche (1) may made via a suitable manufacturing process, such as an extrusion process, for example, but according to one possible embodiment, the present wedge cartouche (1) is designed so that a peripheral contour of the first wedging component (7a) is substantially symmetrical (i.e. similar, identical, etc.) to a peripheral contour of the second wedging component (7b), in which case, both first and second wedging components (7a,7b) can be conveniently manufactured via a similar and/or same extrusion process, and each wedging component (7), whether first and/or second wedging components (7a,7b), and/or combinations thereof, can be conveniently “cut” from a common or same extruded piece, according to intended width(s) and/or other dimensional considerations (ex. size of the line (3), etc.).

According to the embodiments shown in the accompanying figures, the first and second wedging components (7a,7b) are respectively upper and lower wedging components (7a,7b) of the wedge cartouche (1), but as can be easily understood, the first and second wedging components (7a,7b) are not limited to such “vertical” disposition, and may be operated at different angles, including a fully “horizontal” disposition (i.e. “left” and “right” wedging components (7a,7b), for example).

As can be easily understood, the at least one given path (11) can be defined primarily within the lower wedging component (7b). The at least one given path (11) may also include first and second paths (11) defined within the lower and upper wedging components (7a,7b) respectively. Optionally also, the first and second paths (11) may include first and second sloping paths respectively, although other suitable shapes and forms, depending on the particular needs and/or the desired end results, are also contemplated with the present wedge cartouche (1), as previously explained.

Referring now to a possible embodiment of the containment assembly (5), it may include a main body (5a) which is C-shaped, although other suitable shapes and forms are also contemplated with the present wedge cartouche (1), such as an S-shape, for example.

Irrespectively of the shape and form of the containment assembly (5), its main body (5a) may be provided with a projecting flange (5b), and such a projecting flange (5b) may be a downwardly projecting flange (5b), for example, provided with at least one hole (5d), configured for allowing a user of the present system to operate the containment assembly (5) at a distance via an appropriate extension tool, such as a hot stick, for example, cooperating with said at least one hole (5d), and/or alternatively, for facilitating a direct manual handling by a user of the containment assembly (5). The projecting flange (5b) may also include slanted sections (5d), as shown in the accompanying drawings.

As also shown, the wedge cartouche (1) may include a handle assembly (65) for removably maintaining the first and second wedging components (7a,7b) together when located outside of the containment assembly (5), prior to use of the wedge cartouche (1).

According to one possible embodiment, the handle assembly (65) may comprise an insertion pin (67) for removably inserting into a corresponding through-portion (69) of the wedge cartouche (1). As also shown, the handle assembly (65) may comprise front and rear sections (71,73) being connected to one another via a corresponding link (75) or “connecting element”.

The rear section (73) of the handle assembly (65) may comprise a groove (77) being positioned, shaped and sized for removably securing therein a portion of the insertion pin (67).

According to a possible embodiment, the insertion pin (67) is provided with at least one notch (79), which may be V-shaped, for example, and the groove (77) of the rear section (73) of the handle assembly (65) is positioned, shaped and sized for removably securing therein a corresponding notch (79) of the insertion pin (67). Optionally, also, the insertion pin (67) of the handle assembly (65) comprises a plurality of different notches (79), in order to be able to use said handle assembly (65) with wedge cartouches (1) of different sizes (i.e. different widths, etc.).

Furthermore, the rear section (73) of the handle assembly (65) may be positioned, shaped and sized for abutting against the first and second wedging components (7a,7b) of the wedge cartouche (1).

According to a possible embodiment, the rear section (73) of the handle assembly (65) may comprise a rear transversal section (81) for abutting against an outer portion of the wedge cartouche (1).

As can be easily understood when referring to the accompanying drawings, the rear section (73) of the handle assembly (65) is preferably positioned, shaped and sized to disengage from the insertion pin (67) upon contacting a side portion of the containment assembly (5) when the first and second wedging components (7a,7b) are inserted (ex. slid into, etc.) at a predetermined distance within the containment assembly (5).

According to a possible embodiment, the front section (71) of the handle assembly (65) comprises a setting side (83) being positioned, shaped and sized for assisting in a positioning of the first and second wedging components (7a,7b) within the containment assembly (5).

Furthermore, the front section (71) of the handle assembly (65) may comprise a groove (85), being V-shaped, for example, being positioned, shaped and sized for removably securing therein a portion of a retaining pin (43) of the blasting assembly (13).

The front section (71) of the handle assembly (65) may also be positioned, shaped and sized for abutting against the first and second wedging components (7a,7b) of the wedge cartouche (1), and may comprise a front transversal section (87) for abutting against an outer portion of the wedge cartouche (1). According to a possible embodiment, the front transversal section (87) of the handle assembly (65) is positioned, shaped and sized for abutting against an outer portion of both the first and second wedging components (7a,7b) of the wedge cartouche (1).

Optionally also, and as can be easily understood when referring to the accompanying drawings, the front transversal section (87) is provided with a protruding edge (89) for abutting against a corresponding outer slit (91) of the first wedging component (7a) of the wedge cartouche (1).

Additionally, the front section (71) of the handle assembly (65) may comprise a foldable tab (93) operable between opened and closed configurations, the foldable tab (93) being configured for selectively folding in front of the groove (85) of the front section (71) of the handle assembly (65) in order to maintain the retaining pin (43) in said groove (85) of the front section (71) of the handle assembly (65) when operated in the closed configuration.

The foldable tab (93) may be further configured to be removably maintained against the front section (71) of the handle assembly (65), in the closed configuration, via an interlocking assembly (95).

The interlocking assembly (95) may come in various shapes and forms, but according to a possible embodiment, the interlocking assembly (95) comprises complementary male and female components (95a,95b), one of which is present in the foldable tab (93) and another one of which is present in the front section (71) of the handle assembly (65).

The handle assembly (65) may comprise a pulling section (97) operatively connected to the front section (71) of the handle assembly (65), and according to a possible embodiment, the pulling section (97), as well as front and rear sections (71,73) of the handle assembly (65), are made integral to one another (i.e. made of substantially one single piece, and made of substantially one single material, etc.), via a plastic material, such as ABS, for example, although the handle assembly (65) could alternatively be made with different components and/or different materials, and/or different combinations thereof.

In contrast, the first and second wedging components (7a,7b) of the wedge cartouche (1) are preferably made of a metallic material, such a stainless steel or aluminum (ex. for better electrical conductivity, when desired), for example, although other suitable materials are also contemplated for the present wedge cartouche (1).

Preferably, handle assembly (65) is made of a color different than that of the at least one wedging component (7), whether the first and/or second wedging components (7a,7b), in order to enable a user of the wedge cartouche (1) to visually determine at a distance whether or not the handle assembly (25) is mounted onto the wedge cartouche (1).

As may now be better appreciated in view of the above description, the present wedge cartouche (1) is advantageous in that it consists of a competitive wedge-tap which is easier and faster to install then other products known to the Applicant. Moreover, the present wedge cartouche (1) is also advantageous over conventional systems in that a user thereof, does not need to require the use of any specific tools for the installation of the wedge cartouche (1). Indeed, the present wedge cartouche (1) is preferably designed to be “self-sufficient”.

As previously explained, the present wedge cartouche (1), also referred to as “wedge-tap”, may consist of at least two different parts, namely the main body, referred to herein as the containment assembly (5), and the center wedge cartouche or “wedge assembly”, which according to a given embodiment, is filled with a blank cartridge (17).

As also explained herein, and as can be easily understood when referring to the accompanying drawings, a possible manner in which to use the present wedge cartouche (1) is simplified with respect to other conventional systems known to the Applicant.

The way it works can be essentially summarized as follows: inside the wedge assembly, there is a blank cartridge (17) filled with a specific amount of explosive powder (19) taken in a barrel (23) or a canon. This assembly is inoperative and stable until the retaining pin (47), which could simply consist of a conventional nail (51), for example, is removed from the striker (37), after which, this action releases the spring (51) and propels the striker (37) onto the primer (21) of the blank cartridge (17). The shock between the striker (37) and the cartridge (17) results in an explosion or burst of the blank cartridge (17) which builds a pressure zone inside the barrel (23) or canon. As a result thereof, the upper part of the wedge cartouche (1), that is, the top wedging component (7a) is propelled in the canon axis. Consequently, the cables (3) are now tightened against the main body (5a) of the containment assembly (5), and against upper and lower gripping portions (63) of the wedge assembly.

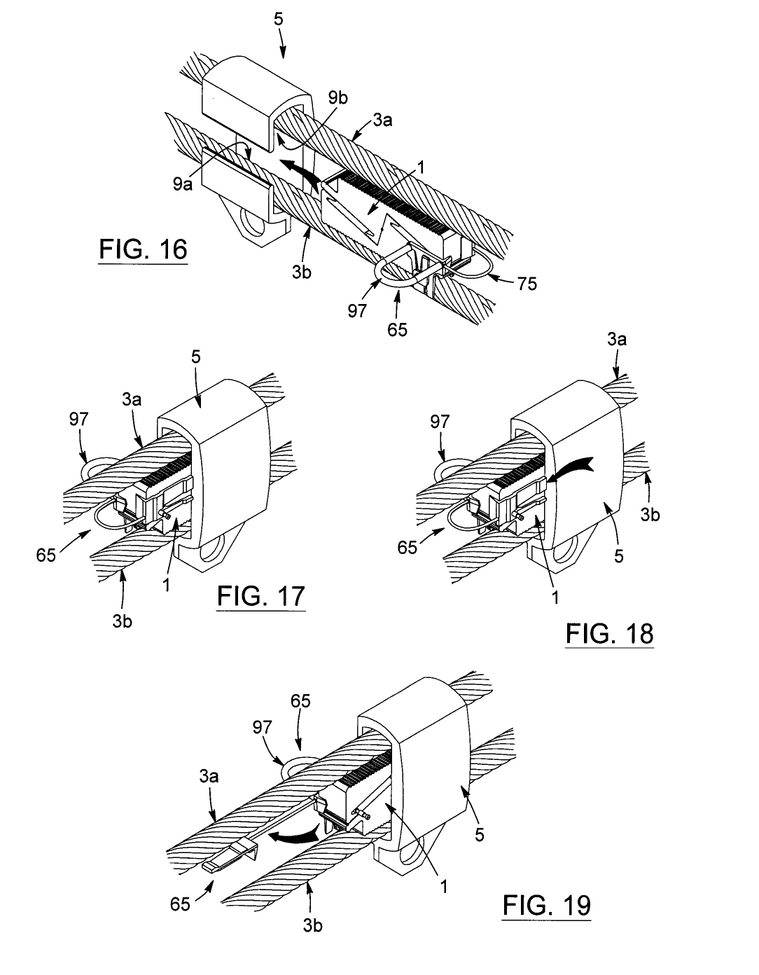

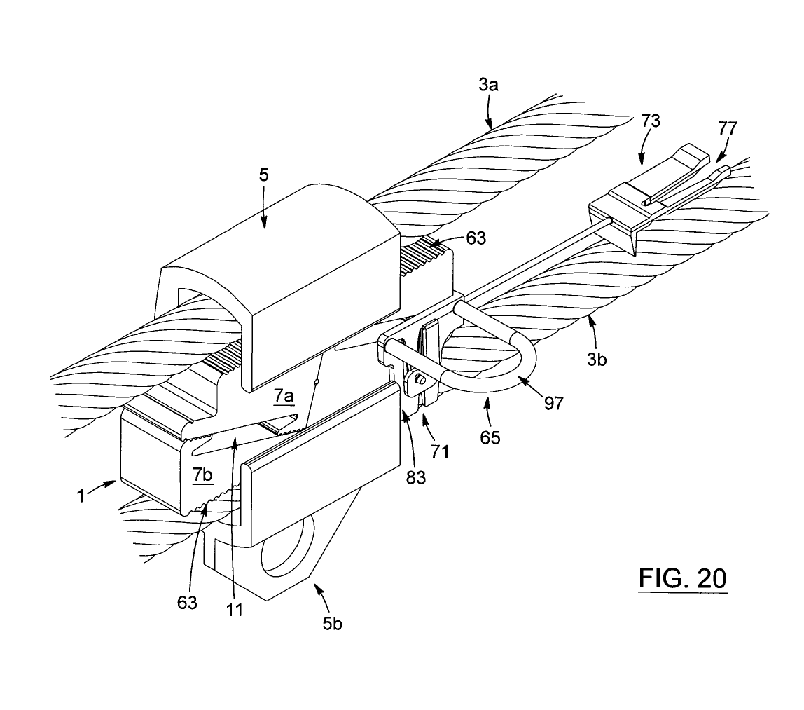

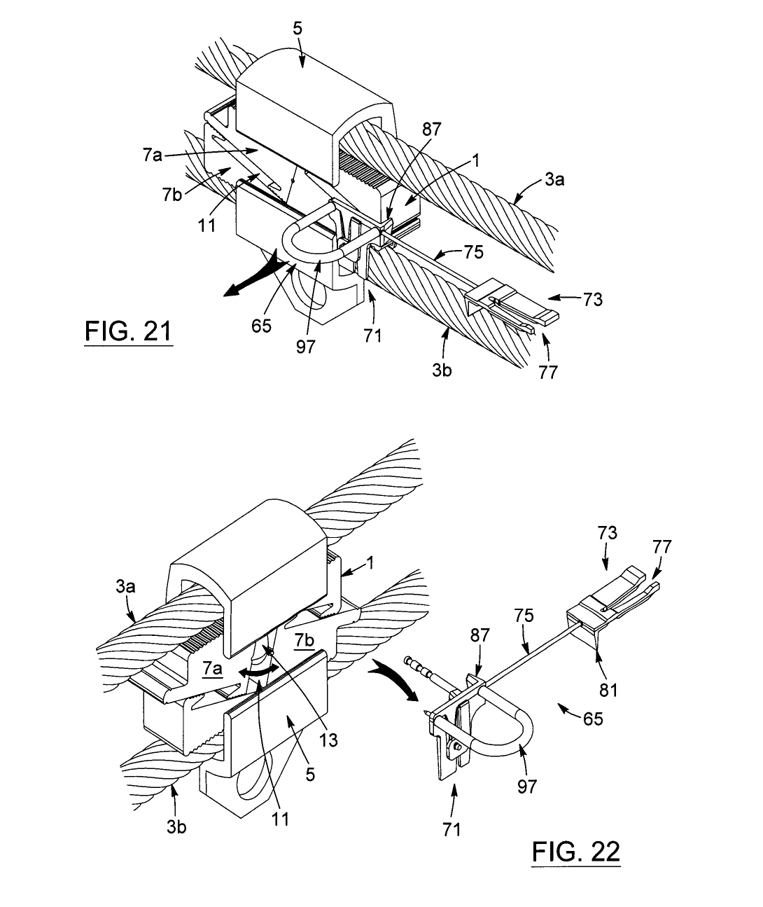

Referring to FIGS. 15-18, in regards to a possible embodiment of the present wedge cartouche (1), one can easily understand that a first step would simply consist to install, as usual, the main body (5) (for example a C-shaped main body) on the two cables (3a,3b), and sliding the wedge assembly (1) between the two cables (3a,3b) using the plastic handle (65). Once the sliding of the wedge assembly (1) inside the main body (5) has taken place, the plastic safety part behind the wedge can be released, and one can afterwards continue to slide the wedge assembly until the front end (83) of the plastic handle touches the main body (5), thereby indicating a an adequate positioning of the wedge assembly (1) inside the containment assembly (5). Afterwards, one simply has to remove the retaining pin (47) (for example, a nail) to release the striker (37) by pulling the plastic handle (97) and the end result is a connexion of at least one line (3), but preferably two lines (3a,3b), via the present wedge cartouche (1).

As can be easily understood, the present wedge cartouche (1) provides several advantages over conventional systems, in that, as mentioned earlier, it is a product that does not need any specific tool for its installation. It is also advantageous that it is very fast to install. By virtue of its design, the product is meant to be easily installed at a proper position within the containment assembly (5). The product is also safe to use, in that, there is little or no noise, and no projectile, and also, no specific licence is required due to the use of blank cartouches, etc.

The present wedge cartouche (1) has also been designed to be safe when manipulating in that the handle assembly (65), is a safety component that the handle (97) cannot be removed during manipulation.

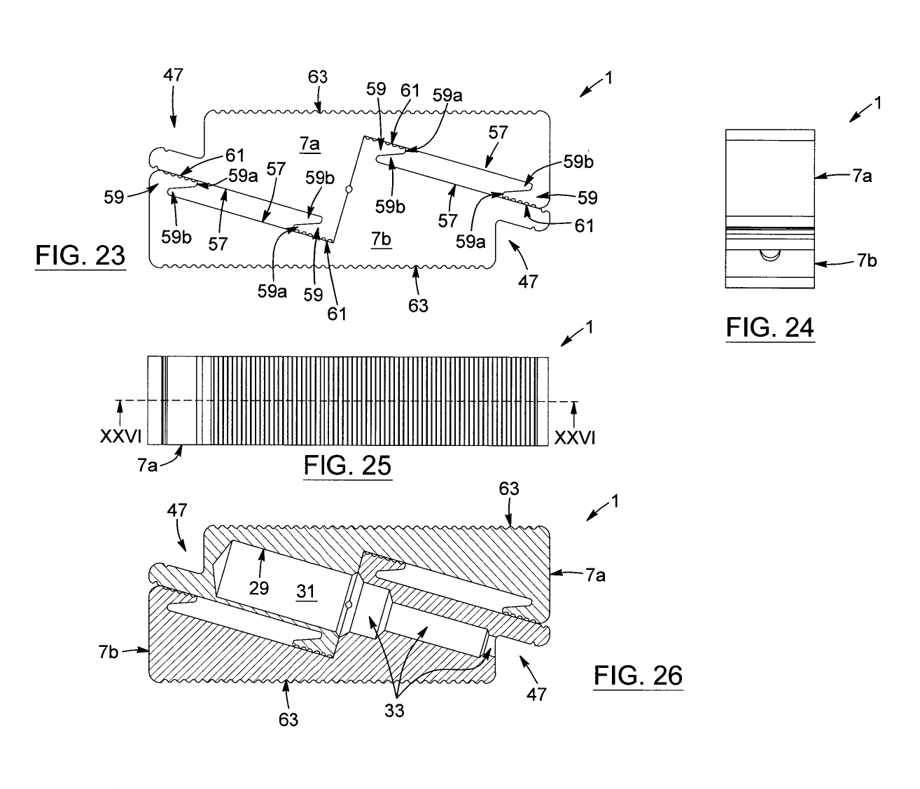

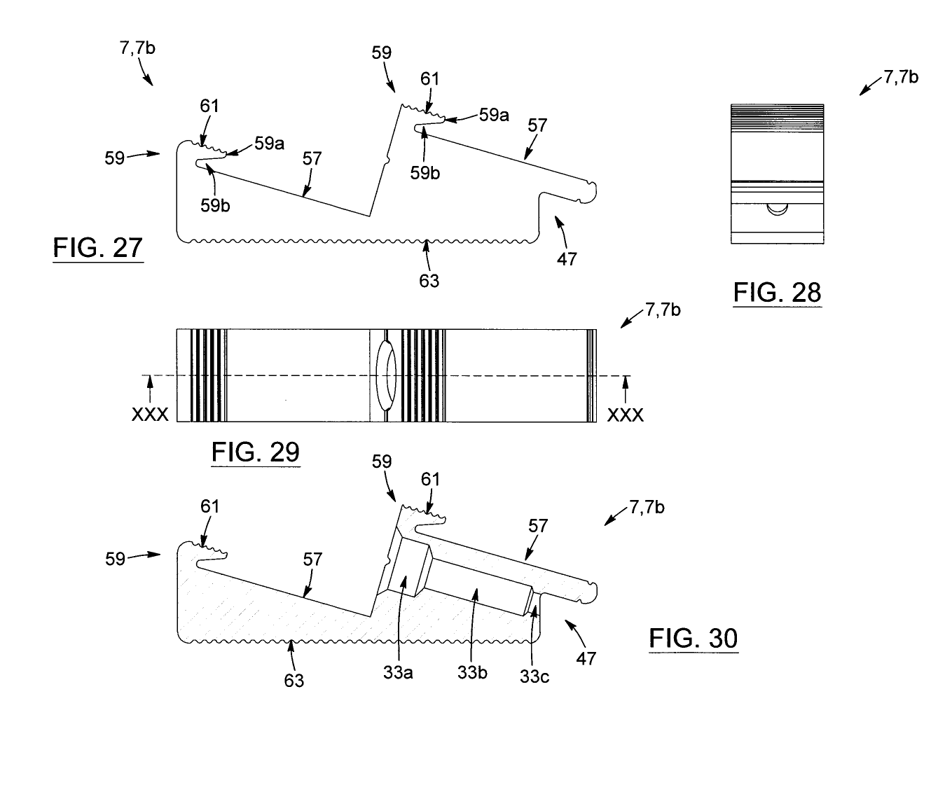

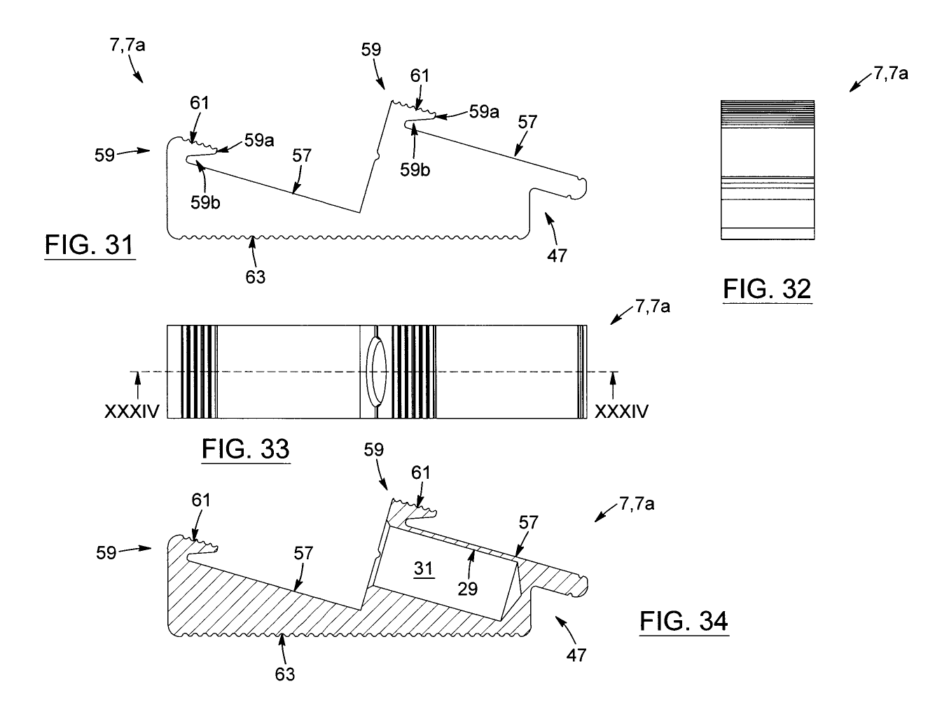

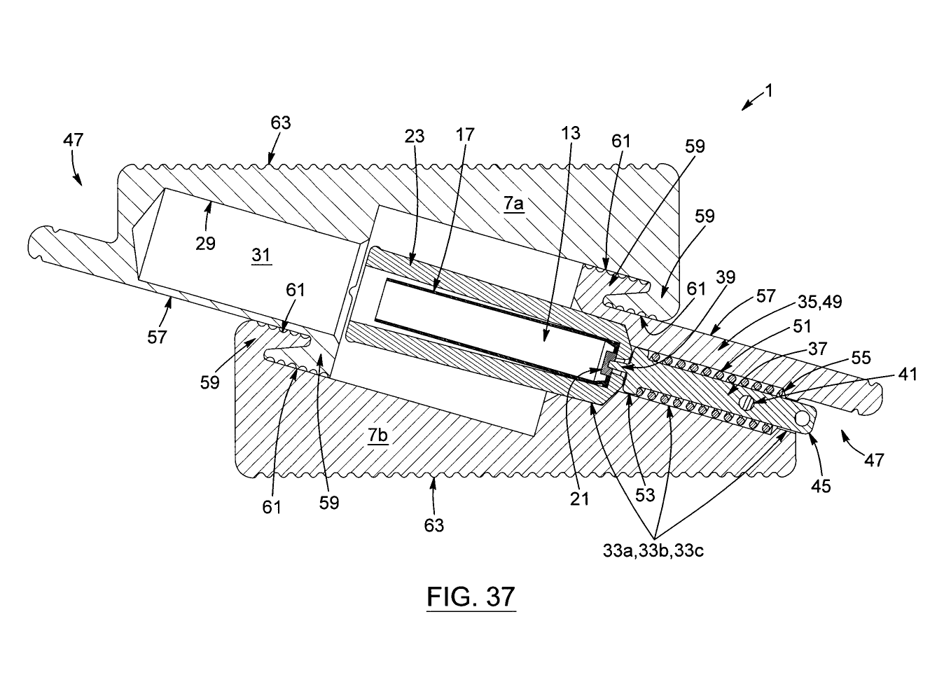

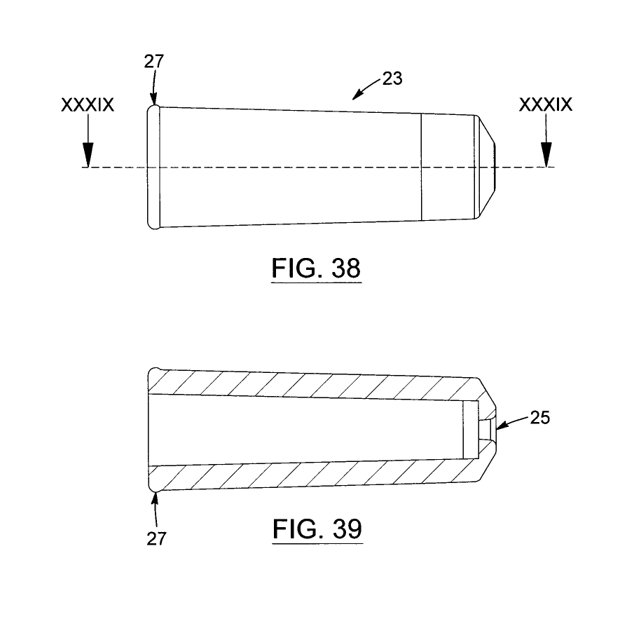

Furthermore, as can be easily understood when referring to FIGS. 23-26 and 37, the present wedge cartouche (1) is also intended to be safe in that even it is accentually triggered outside of the containment assembly (5), the hooks (59) withstand both wedging components (7a,7b) together, and in this particular configuration, the pressure is released from the assembly by the space defined between the barrel and the upper wedge component (7a).

Thus, in view of the above, and as may now be better appreciated, the present wedge cartouche is advantageous over other related wedging devices and/or methods in that it enables to wedge a portion of at least one line (and/or to wedge at pair of power lines together for an electric connection thereinbetween, for example) in a simpler, easier, faster, cleaner and/or more convenient manner than what is possible with other conventional systems.

Finally, and as can be easily understood, the present wedge cartouche (1) and corresponding parts can be made of substantially rigid materials, such as metallic materials, hardened polymers, composite materials, and/or the like, as well as other possible combinations thereof, depending on the particular applications for which the tensioning assembly (1) is intended, and the desired end results.

Of course, and as can be easily understood by a person skilled in the art, the scope of the claims should not be limited by the possible embodiments set forth in the examples, but should be given the broadest interpretation consistent with the description as a whole.

1. A wedge cartouche (1) for use with at least one line (3) and corresponding containment assembly (5), the wedge cartouche (1) comprising:
at least one wedging component (7) being positioned, shaped and sized for inserting inside the containment assembly (5), adjacent to the at least one line (3) having a segment (9) extending through said containment assembly (5), the at least one wedging component (7) being moveable along at least one given path (11), and being operable between opposite drawn-in and drawn-out configurations along said at least one given path (11); and
a blasting assembly (13) for propelling the at least one wedging component (7) into the drawn-out configuration, in order to operatively secure the segment (9) of the at least one line (3) between a receiving portion (15) of the containment assembly (5) and said at least one drawn-out wedging component (7).

2. A wedge cartouche (1) according to claim 1, wherein the blasting assembly (13) includes a blank cartridge (17) having propellant (19) and a corresponding priming component (21) for igniting the propellant (19).

3. A wedge cartouche (1) according to claim 2, wherein the blasting assembly (13) includes a barrel (23) for containing the blank cartridge (17) inside said barrel (23).

4. A wedge cartouche (1) according to claim 3, wherein the barrel (23) comprises an orifice (25) for exposing the priming component (21) of the blank cartridge (17).

5. A wedge cartouche (1) according to claim 3 or 4, wherein the barrel (23) is made of a resilient material, and wherein an outer distal rim (27) of the barrel (23) is positioned, shaped and sized for resting against an inner wall (29) of an inner cavity (31) of the at least one wedging component (7) in order to assist in containing an explosive effect of the blank cartridge (17) inside said inner cavity (31) of the at least one wedging component (7).

6. A wedge cartouche (1) according to any one of claims 3-5, wherein the barrel (23) is made of a color different than that of the at least one wedging component (7), and wherein the barrel (23) is positioned, shaped and sized about the wedge cartouche (1) so as to have an exposed portion after the blasting assembly (13) has propelled the at least one wedging component (7), in order to enable a user of the wedge cartouche (1) to visually determine at a distance when the at least one wedging component (7) is in the drawn-out configuration.

7. A wedge cartouche (1) according to any one of claims 1-6, wherein the at least one wedging component (7) comprises a first recess (33a) for removably receiving a first portion of the blasting assembly (13).

8. A wedge cartouche (1) according to claim 7, wherein the at least one wedging component (7) comprises a second recess (33b) for removably receiving a detonating assembly (35) being configured for selectively detonating the blasting assembly (13).

9. A wedge cartouche (1) according to claim 8, wherein the detonating assembly (35) comprises a striking component (37) extendable through the second recess (33b), the striking component (37) having a striking tip (39) being configured for striking the priming component (21) of the blank cartridge (17).

10. A wedge cartouche (1) according to claim 9, wherein the at least one wedging component (7) comprises a third recess (33c) for removably receiving the striking component (37) being extendable through said third recess (33c), the striking component (37) including a hole (41) for receiving a corresponding retaining pin (43) of the detonating assembly (35).

11. A wedge cartouche (1) according to any one of claims 1-10, wherein the at least one wedging component (7) comprises a common recess (33) having corresponding different cross-sectional areas.

12. A wedge cartouche (1) according to claim 9 or 10, wherein the striking component (37) comprises a protruding portion (45) extendable outwardly from the at least one wedging component (7), and wherein a portion of the striking component (37) is positionable outside of the at least one wedging component (7) when the striking component (37) is in a retracted position.

13. A wedge cartouche (1) according to claim 12, wherein the at least one wedging component (7) comprises a cut-out section (47) for receiving the protruding portion (45) of the striking component (37).

14. A wedge cartouche (1) according to any one of claims 9-13, wherein the striking component (37) is urged towards the blank cartridge (17) via a biasing assembly (49), and wherein the striking component (37) is selectively maintained in a retracted configuration via a retaining mechanism (43).

15. A wedge cartouche (1) according to claim 14, wherein the retaining mechanism (43) is insertable into a hole (41) of the striking component (37) when the striking component (37) is in the retracted configuration.

16. A wedge cartouche (1) according to claim 9, 14 or 15, wherein the retaining mechanism (43) is further positioned, shaped and sized for abutting against an outer portion of the at least one wedging component (7), in order to selectively prevent the striking component (37) from being urged towards the blank cartridge (17).

17. A wedge cartouche (1) according to any one of claims 9-16, wherein the striking component (37) is spring-loaded via a corresponding spring (51) insertable into a corresponding recess (33) of the at least one wedging component (7), the spring (51) being extendable between a shouldering portion (53) of the striking component (37) and a corresponding inner edge (55) of the at least one wedging component (7).

18. A wedge cartouche (1) according to any one of claims 1-17, wherein the at least one wedging component (7) comprises first and second wedging components (7a,7b) being positioned, shaped and sized for inserting inside the containment assembly (5), adjacent to the at least one line (3) having the segment (9) extending through said containment assembly (5), and wherein the first and second components (7a,7b) are moveable with respect to one another along the at least one given path (11), and are operable between opposite drawn-in and drawn-out configurations along said at least one given path (11).

19. A wedge cartouche (1) according to claim 18, wherein the at least one given path (11) is a slanted path.

20. A wedge cartouche (1) according to claim 18 or 19, wherein the first and second wedging components (7a,7b) are moveable with respect to one another so as to increase an effective height (h) of the wedge cartouche (1) upon a detonation of the blasting assembly (13), in order to forcefully jam the segment (9) of the at least one line (7) against the receiving portion (15) of the containment assembly (5).

21. A wedge cartouche (1) according to any one of claims 18-20, wherein the first wedging component (7a) comprises at least one sloping section (57).

22. A wedge cartouche (1) according to any one of claims 18-21, wherein the first wedging component (7a) comprises first and second sloping sections (57).

23. A wedge cartouche (1) according to any one of claims 18-22, wherein the second wedging component (7b) comprises at least one sloping section (57).

24. A wedge cartouche (1) according to any one of claims 18-23, wherein the second wedging component (7b) comprises first and second sloping sections (57).

25. A wedge cartouche (1) according to any one of claims 18-24, wherein the second wedging component (7b) comprises a first sliding section (59) configured for sliding along a corresponding first section of the first wedging component (7a).

26. A wedge cartouche (1) according to claim 25, wherein the first section of the first wedging component (7a) includes at least one sloping section (57).

27. A wedge cartouche (1) according to claim 25 or 26, wherein the second wedging component (7b) comprises a second sliding section (59) configured for sliding along a corresponding second section of the first wedging component (7a).

28. A wedge cartouche (1) according to claim 27, wherein the second section of the first wedging component (7a) includes at least one sloping section (57).

29. A wedge cartouche (1) according to any one of claims 18-28, wherein the first wedging component (7a) comprises a first sliding section (59) configured for sliding along a corresponding first section of the second wedging component (7b).

30. A wedge cartouche (1) according to claim 29, wherein the first section of the second wedging component (7b) includes at least one sloping section (57).

31. A wedge cartouche (1) according to claim 29 or 30, wherein the first wedging component (7a) comprises a second sliding section (59) configured for sliding along a corresponding second section of the second wedging component (7b).

32. A wedge cartouche (1) according to claim 31, wherein the second section of the second wedging component (7b) includes at least one sloping section (57).

33. A wedge cartouche (1) according to any one of claims 25-32, wherein each sliding section (59) is hook-shaped, with a tapered section (59a) and a grooved section (59b), the tapered section (59a) of a sliding section (59) of one wedging component (7a,7b) being configured for abutting into the grooved section (59b) of a sliding section (59) of another wedging component (7b,7a).

34. A wedge cartouche (1) according to any one of claims 25-33, wherein each sliding section (59) includes an outer gripping section (61), the outer gripping section (61) of a sliding section (59) of one wedging component (7a,7b) being configured for gripping into a corresponding section of another wedging component (7b,7a).

35. A wedge cartouche (1) according to claim 34, wherein said corresponding section of another wedging component (7b,7a) includes at one sloping section (57).

36. A wedge cartouche (1) according to claim 34 or 35, wherein each outer gripping section (61) of each sliding section (59) is provided with surface-texturing for improved gripping when the wedge cartouche (1) is propelled into the drawn-out configuration by the blasting assembly (13).

37. A wedge cartouche (1) according to claim 36, wherein the surface-texturing includes peaked undulations.

38. A wedge cartouche (1) according to any one of claims 18-37, wherein each wedging component (7a,7b) includes an outer gripping section (63), the outer gripping section (63) of each wedging component (7a,7b) being configured for gripping into the segment (9) of the at least one line (7) to be secured onto the receiving portion (15) of the containment assembly (5).

39. A wedge cartouche (1) according to any one of claims 18-38, wherein the first and second wedging components (7a,7b) each include an outer gripping section (63), the outer gripping section (63) of the first wedging component (7a) being configured for gripping into a segment (9a) of a first line (3a) to be secured onto a first receiving portion (15a) of the containment assembly (5), and the outer gripping section (63) of the second wedging component (7b) being configured for gripping into a segment (9b) of a second line (3b) to be secured onto a second receiving portion (15b) of the containment assembly (5).

40. A wedge cartouche (1) according to claim 38 or 39, wherein each outer gripping section (63) of each wedging component (7a,7b) is provided with surface-texturing for improved gripping when the wedge cartouche (1) is propelled into the drawn-out configuration by the blasting assembly.

41. A wedge cartouche (1) according to claim 40, wherein the surface-texturing includes rounded undulations.

42. A wedge cartouche (1) according to any one of claims 18-41, wherein a peripheral contour of the first wedging component (7a) is symmetrical to a peripheral contour of the second wedging component (7b).

43. A wedge cartouche (1) according to any one of claims 18-42, wherein the first and second wedging components (7a,7b) are made via an extrusion process.

44. A wedge cartouche (1) according to any one of claims 18-43, wherein the first and second wedging components (7a,7b) are respectively upper and lower wedging components (7a,7b) of the wedge cartouche (1).

45. A wedge cartouche (1) according to claim 44, wherein the at least one given path (11) is defined within the lower wedging component (7b).

46. A wedge cartouche (1) according to claim 44 or 45, wherein the at least one given path (11) includes first and second paths (11) defined within the lower and upper wedging components (7a,7b) respectively.

47. A wedge cartouche (1) according to claim 46, wherein the first and second paths (11) include first and second sloping paths respectively.

48. A wedge cartouche (1) according to any one of claims 1-47, wherein the containment assembly (5) includes a main body (5a).

49. A wedge cartouche (1) according to claim 48, wherein the main body (5a) of the containment assembly (5) is C-shaped.

50. A wedge cartouche (1) according to claim 48, wherein the main body (5a) of the containment assembly (5) is S-shaped.

51. A wedge cartouche (1) according to claim 49 or 50, wherein the main body (5a) of the containment assembly (5) is provided with a projecting flange (5b).

52. A wedge cartouche (1) according to claim 51, wherein the projecting flange (5b) is a downwardly projecting flange (5b) provided with at least one hole (5d).

53. A wedge cartouche (1) according to claim 51 or 52, wherein the projecting flange (5b) includes slanted sections (5d).

54. A wedge cartouche (1) according to any one of claims 18-53, wherein the wedge cartouche (1) comprises a handle assembly (65) for removably maintaining the first and second wedging components (7a,7b) together when located outside of the containment assembly (5), prior to use of the wedge cartouche (1).

55. A wedge cartouche (1) according to claim 54, wherein the handle assembly (65) comprises an insertion pin (67) for removably inserting into a corresponding through-portion (69) of the wedge cartouche (1).

56. A wedge cartouche (1) according to claim 54 or 55, wherein the handle assembly (65) comprises front and rear sections (71,73) being connected to one another via a corresponding link (75).

57. A wedge cartouche (1) according to claim 56, wherein the rear section (73) of the handle assembly (65) comprises a groove (77) being positioned, shaped and sized for removably securing therein a portion of the insertion pin (67).

58. A wedge cartouche (1) according to claim 57, wherein the insertion pin (67) is provided with at least one notch (79), and wherein the groove (77) of the rear section (73) of the handle assembly (65) is positioned, shaped and sized for removably securing therein a corresponding notch (79) of the insertion pin (67).

59. A wedge cartouche (1) according to any one of claims 55-58, wherein the insertion pin (67) of the handle assembly (65) comprises a plurality of different notches (79) in order to use said handle assembly (65) with wedge cartouches (1) of different sizes.

60. A wedge cartouche (1) according to claim 57 or 58, wherein the groove (77) of the rear section (73) of the handle assembly (65) is V-shaped.

61. A wedge cartouche (1) according to any one of claims 56-60, wherein the rear section (73) of the handle assembly (65) is positioned, shaped and sized for abutting against the first and second wedging components (7a,7b) of the wedge cartouche (1).

62. A wedge cartouche (1) according to any one of claims 56-61, wherein the rear section (73) of the handle assembly (65) comprises a rear transversal section (81) for abutting against an outer portion of the wedge cartouche (1).

63. A wedge cartouche (1) according to any one of claims 56-62, wherein the rear section (73) of the handle assembly (65) is positioned, shaped and sized to disengage from the insertion pin (67) upon contacting a side portion of the containment assembly (5) when the first and second wedging components (7a,7b) are inserted at a predetermined distance within the containment assembly (5).

64. A wedge cartouche (1) according to any one of claims 56-63, wherein the front section (71) of the handle assembly (65) comprises a setting side (83) being positioned, shaped and sized for assisting in a positioning of the first and second wedging components (7a,7b) within the containment assembly (5).

65. A wedge cartouche (1) according to any one of claims 56-64, wherein the front section (71) of the handle assembly (65) comprises a groove (85) being positioned, shaped and sized for removably securing therein a portion of a retaining pin (43) of the blasting assembly (13).

66. A wedge cartouche (1) according to claim 65, wherein the groove (85) of the front section (71) of the handle assembly (65) is V-shaped.

67. A wedge cartouche (1) according to any one of claims 56-66, wherein the front section (71) of the handle assembly (65) is positioned, shaped and sized for abutting against the first and second wedging components (7a,7b) of the wedge cartouche (1).

68. A wedge cartouche (1) according to any one of claims 56-67, wherein the front section (71) of the handle assembly (65) comprises a front transversal section (87) for abutting against an outer portion of the wedge cartouche (1).

69. A wedge cartouche (1) according to claim 68, wherein the front transversal section (87) is positioned, shaped and sized for abutting against an outer portion of both the first and second wedging components (7a,7b) of the wedge cartouche (1).

70. A wedge cartouche (1) according to claim 69, wherein the front transversal section (87) is provided with a protruding edge (89) for abutting against a corresponding outer slit (91) of the first wedging component (7a) of the wedge cartouche (1).

71. A wedge cartouche (1) according to any one of claims 65-70, wherein the front section (71) of the handle assembly (65) comprises a foldable tab (93) operable between opened and closed configurations, the foldable tab (93) being configured for selectively folding in front of the groove (85) of the front section (71) of the handle assembly (65) in order to maintain the retaining pin (43) in said groove (85) of the front section (71) of the handle assembly (65) when operated in the closed configuration.

72. A wedge cartouche (1) according to claim 71, wherein the foldable tab (93) is further configured to be removably maintained against the front section (71) of the handle assembly (65), in the closed configuration, via an interlocking assembly (95).

73. A wedge cartouche (1) according to claim 72, wherein the interlocking assembly (95) comprises complementary male and female components (95a,95b), one of which is present in the foldable tab (93) and another one of which is present in the front section (71) of the handle assembly (65).

74. A wedge cartouche (1) according to any one of claims 54-73, wherein the handle assembly (65) comprises a pulling section (97) operatively connected to the front section (71) of the handle assembly (65).

75. A wedge cartouche (1) according to claim 74, wherein the pulling section (97), as well as front and rear sections (71,73) of the handle assembly (65), are made integral to one another.

76. A wedge cartouche (1) according to any one of claims 54-75, wherein the handle assembly (65) is made of a color different than that of the at least one wedging component (7), in order to enable a user of the wedge cartouche (1) to visually determine at a distance whether or not the handle assembly (25) is mounted onto the wedge cartouche (1).

77. A wedge cartouche (1) according to any one of claims 54-76, wherein the handle assembly (65) and corresponding sections thereof are made of a plastic material.

78. A wedge cartouche (1) according to any one of claims 18-77, wherein the first and second wedging components (7a,7b) of the wedge cartouche (1) are made of a metallic material.

79. A kit with corresponding components for assembling a wedge cartouche (1) according to any one of claims 1-78.
